(19) United States
(12) Patent Application Publication
(10) Pub. No.: US 2018/0173348 A1
(43) Pub. Date: Jun. 21, 2018

(54) ARRAY SUBSTRATE AND TOUCH DISPLAY

(71) Applicant: Wuhan China Star Optoelectronics Technology Co., Ltd., Wuhan, Hubei (CN)

(72) Inventors: Yao-li HUANG, Shenzhen, Guangdong (CN); Hongsen ZHANG, Shenzhen, Guangdong (CN)

(73) Assignee: Wuhan China Star Optoelectronics Technology Co., Ltd., Wuhan, Hubei (CN)

(21) Appl. No.: 15/300,250

(22) PCT Filed: Aug. 1, 2016
(86) PCT No.: PCT/CN2016/092710

§ 371 Date: Sep. 28, 2016

(30) Foreign Application Priority Data
Jul. 18, 2016 (CN) 201610566408.4

(51) Int. Cl. G06F 3/041; G02F 1/1333; G02F 1/1362

(52) U.S. Cl. CPC G06F 3/0412; G06F 3/0416; G02F 2201/121; G02F 1/136286; G02F 1/133345; G02F 1/13338

(57) ABSTRACT

An array at least includes a substrate; a common electrode layer, an insulating layer and a sensing layer disposed thereon overlapped in sequence. The common electrode layer includes a plurality of sensors disposed separately. A touch control lead wire and a suspension lead wire are disposed on the sensing layer corresponding to each of the sensors. The touch control lead wires are connected to the sensors electrically through a first via hole. The suspension lead wire and the touch control lead wire are separated and disposed parallel, and the suspension lead wires are connected to the sensors electrically through a second via hole. Which can prevent the electric field generated by a data line below the sensors from fleeing to a liquid crystal layer above through regions between the sensors to drive rotation of liquid crystals and resulting in light leakage of the position as well as mura.

### CROSS REFERENCE

This disclosure claims priority to Chinese patent application No. 201610566408.4, entitled “ARRAY SUBSTRATE AND TOUCH DISPLAY” filed on Jul. 18, 2016, which is incorporated by reference in its entirety.

### FIELD OF THE DISCLOSURE

The disclosure relates to a touch control field, specifically in a touch display field, and more particularly to an array substrate and a touch display.

### BACKGROUND OF THE DISCLOSURE

As intense competition of the mobile phone market is upgrading, integration of touch control and display (abbreviated as touch display integration) confronts another round of competition. Incell technology is regarded as high tech in the field and widely favored. The incell technology indicates to embed a touch control panel function in a liquid crystal pixel.

In a conventional self-contained touch control technology, a common electrode is generally cut to form multiple sensors distributed as a matrix, a cutting slit exists between adjacent sensors of the multiple sensors. Digging slits is executed on the common electrode of a touch control lead wire with an subpixel as an element to reduce capacity between the sensors and the touch control lead wire, as the cutting slit exists between adjacent sensors of the multiple sensors, when an electric field generated by a data line transporting signals goes through the cutting slit between the sensors, liquid crystals corresponding to the cutting slit will be affected to disturb liquid crystal orientation herein, resulting in light leakage of the position, as well as increasing a risk of mura appearance, which will influence optical quality of a built-in touch display.

### SUMMARY OF THE DISCLOSURE

An objective of the disclosure is to provide an array substrate, the array substrate can reduce a risk of light leakage efficiently and prevent appearance of vertical mura.

Another objective of the disclosure is to provide a touch display with the array substrate mentioned above.

To achieve the previous objectives, embodiments of the disclosure are as follows.

The disclosure provides an array substrate, at least including a substrate; a common electrode layer, an insulating layer and a sensing layer disposed on the substrate overlapped in sequence. The common electrode layer includes a plurality of sensors, the plurality of sensors are disposed separately. A touch control lead wire and a suspension lead wire are disposed on the sensing layer corresponding to each of the sensors. The touch control lead wires are connected to the sensors electrically through a first via hole. The suspension lead wire and the touch control lead wire are separated and disposed parallel, and the suspension lead wires are connected to the sensors electrically through a second via hole.

The plurality of sensors are arrayed as an array, each of the sensors is corresponding to two or more touch control lead wires and one suspension lead wire respectively.

The plurality of touch control lead wires corresponding to the identical sensor are arranged parallel, each of the touch control lead wires and the sensors are connected electrically through the plurality of first via holes.

The plurality of touch control lead wires corresponding to the identical sensor and the suspension lead wires are arranged parallel with an identical extension direction.

The suspension lead wires of the plurality of sensors are insulated respectively, and each of the suspension lead wires and the corresponding sensor are connected electrically through the second via hole.

The array substrate further comprises a touch control driver and a peripheral lead wire, each of the sensors is connected to the touch control driver by the peripheral lead wire.

The touch control lead wire corresponding to each of the sensors and the peripheral lead wire are connected electrically.

The touch control lead wires and the suspension lead wires are metallic wires disposed on the insulating layer.

The array substrate further includes a gate line and a data line crosswise arranged on the substrate, the touch control lead wires are above the gate line, the touch control lead wires and the gate line are insulated.

The disclosure provides a touch display, including the array substrate.

Embodiments of the disclosure have following advantages or benefit effects.

In the disclosure, the suspension lead wires and the touch control lead wires are connected electrically through via holes to reduce an electric field difference generated by light leakage from the cutting slit, further preventing the electric field generated by the data line below the sensors from fleeing to the liquid crystal layer above through regions between the sensors and forming a horizontal electric field to drive rotation of liquid crystals, which results in light leakage of the position and appearance of mura.

### BRIEF DESCRIPTION OF THE DRAWINGS

In order to more clearly illustrate embodiments of the disclosure, following figures described in embodiments will be briefly introduced, it is obvious that the drawings are merely some embodiments of the disclosure, a person skilled in the art can obtain other figures according to these figures without creativity.

FIG. 1 is a schematic, structural view of an array substrate according to the disclosure.

FIG. 2 is an enlarged schematic view of A shown in FIG.1.

FIG. 3 is a schematic, structural view of a touch display according to the disclosure.

### DETAILED DESCRIPTION OF PREFERRED EMBODIMENTS

Embodiments of the disclosure will be described in detail with reference to the accompanying drawings as follows, obviously, the described embodiments are part of embodiments of the disclosure rather than all of them. Based on the embodiments of the disclosure, all other embodiments obtained by a person skilled in the art without creativity should be considered within the scope of protection of the disclosure.

Furthermore, description of the embodiments is referred to figures for illustration. An orientation word mentioned in the disclosure, for instance, “above”, “below”, “front”, “rear”, “left”, “right”, “in”, “out”, “side”, is merely a reference according to figures, therefore, the orientation word is utilized for better explaining and understanding the disclosure, rather than restricting orientations of a device or an element, for which cannot be regarded as limitation of the disclosure.

In description of the disclosure, it is necessary to clarify that unless other regulations or limitations exist, terms “install”, “connect”, “link”, “dispose on” should adopt generalized meanings, for instance, a connection can be fixed, or detachable, or integrated; the connection can be mechanical; the connection can be direct, or indirect with an intermediary, or a joint within two elements. The terms above can be comprehended by a person skilled in the art according to a specific circumstance.

Furthermore, in description of the disclosure, unless otherwise stated, “a plurality of” indicates two or more. A term “process” in the disclosure can indicate an independent process, when it is difficult to be distinguished from other processes, other processes that can achieve the purpose of the process can also be included. Moreover, a numerical range represents by “˜” in the disclosure means a range defined by two values on two sides of “˜” respectively as a minimum value and a maximum value. In the figures, units with similar or same structures are represented by the same label.

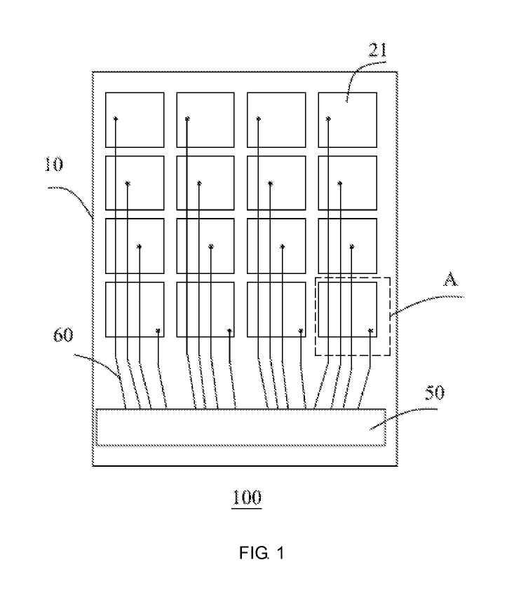

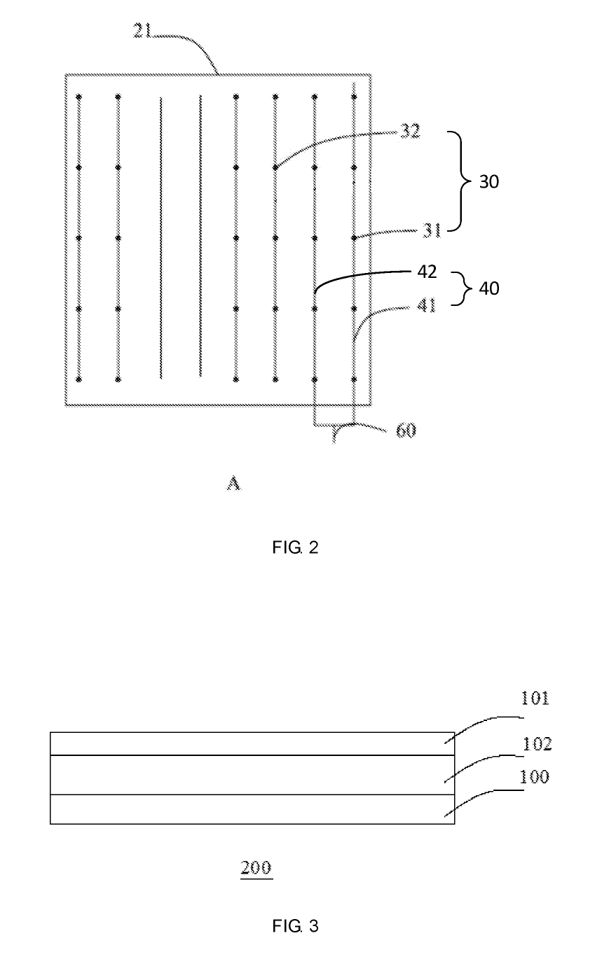

Referring to FIG. 1˜FIG. 2, an array substrate 100 of the disclosure includes a substrate 10, a common electrode layer (not labelled in the figures), an insulating layer 30 and a sensing layer 40, the common electrode layer is formed on the substrate 10, the insulating layer 30 is painted on and covering the common electrode layer, the sensing layer 40 is formed on a surface of the insulating layer 30 away from the substrate 10. The common electrode layer includes a plurality of sensors 21, the plurality of sensors 21 are disposed separately. A touch control lead wire 41 and a suspension lead wire 42 are disposed on the sensing layer 40 corresponding to each of the sensors 21. The touch control lead wires 41 are connected to the sensors 21 electrically through a first via hole 31. The suspension lead wire 42 and the touch control lead wire 41 are separated and disposed parallel, and the suspension lead wire 42 is connected to the sensors 21 electrically through a second via hole 32. The touch control lead wires and the suspension lead wires are metallic wires disposed on the insulating layer.

Specifically, the sensing layer 40 includes the plurality of touch control lead wires 41 and the plurality of suspension lead wires 42. The touch control lead wires 41 are disposed opposite to the sensors 21, in other words, orthographic projection of the touch control lead wires 41 on the substrate 10 is mostly located on the sensors 21. The touch control lead wire 41 and the sensors 21 are connected electrically through the first via hole 31 defined in the insulating layer 30. The suspension lead wires 42 are disposed in one of the sensor 21 on the insulating layer 30, arranged evenly with the corresponding touch control lead wires, and the suspension lead wires 42 and the corresponding sensors 21 are connected through a second via hole 32. In the embodiment, one of the sensors is connected with two parallel connected touch control lead wires, one suspension lead wire 42 corresponding to the touch control lead wires 41 in the one sensor is on a side of the touch control lead wires 41. In other embodiments, one sensor can further be disposed with one touch control lead wire 41. The array substrate further includes a pixel electrode, the pixel electrode is between the touch control lead wires 41 and the suspension lead wires 42. The array substrate further includes a gate line and a data line crosswise arranged on the substrate 10, the touch control lead wires 41 are above the gate line, the touch control lead wires and the gate line are insulated.

In the disclosure, the suspension lead wires and the touch control lead wires are connected electrically to reduce an electric field difference generated by light leakage from the cutting slit, further preventing the electric field generated by the data line below the sensors from fleeing to the liquid crystal layer above through regions between the sensors and forming a horizontal electric field to drive rotation of liquid crystals, which results in light leakage of the position and appearance of mura.

In order to detect the technical effect of the disclosure, simulation of two situations by a simulation software—the suspension lead wires connected to the sensors (sensor) and the suspension lead wired disconnected to the sensors (sensor-f)—is processed, a pixel optical simulation result in darkness is obtained as a following table.

Simulation test results

| Visual | Brightness relative magnitude | | |
|---|---|---|---|
| angle | sensor | sensor-f | Δ sensor |
| 60 | 0.447 | 0.612 | 34% |
| 45 | 0.323 | 0.493 | 49% |
| 30 | 0.261 | 0.425 | 58% |
| 0 | 0.242 | 0.396 | 60% |
| −30 | 0.261 | 0.424 | 58% |
| −45 | 0.322 | 0.492 | 49% |
| −60 | 0.446 | 0.612 | 34% |

Labelling data in the table above in a coordinate axis, a horizontal axis in the figure indicates the visual angle, a vertical axis indicates the brightness relative magnitude. For instance, when the visual angle is 60 degrees, brightness relative magnitude while the suspension lead wires are connected to the sensor is 0.447, brightness relative magnitude while the suspension lead wires are disconnected to the sensor is 0.612. Which means brightness relative magnitude decreases 34% comparing the suspension lead wire connected to the sensor and the suspension lead wire disconnected to the sensor, so as to reduce light leakage efficiently. It can also be seen from the figure, at any visual angle, when the suspension lead wires are disconnected with the sensor, brightness of dark pixel is higher than that while the suspension lead wires are connected to the sensor, representing a higher risk of leaking light. The disclosure can reduce the risk of light leakage efficiently and assist to prevent mura during display.

In a specific embodiment of the disclosure, the plurality of sensors 21 are arrayed as an array, each of the sensors 21 is corresponding to two or more touch control lead wires 41 and one suspension lead wire 42 respectively, the plurality of touch control lead wires 41 corresponding to the identical sensor 21 are disposed parallel, an extension direction of the one suspension lead wire 42 and that of the plurality of touch control lead wires 41 corresponding to the identical sensor are the same. In other words, the amount of the suspension lead wires 42 and that of the sensors 21 are equal. Preferably, the plurality of suspension lead wires 42 corresponding to various sensors 21 are insulated mutually. Each of the touch control lead wires 41 and the sensors 21 are connected electrically through the plurality of first via holes. Moreover, the suspension lead wires 42 of the plurality of sensors 21 are insulated mutually, and each of the suspension lead wires 42 and the corresponding sensor 21 are connected electrically through the second via hole.

In an optional implementation manner of the embodiment, one suspension lead wire 42 is disposed between two touch control lead wires 41 of each of the sensors 21. It needs to be illustrated that a specific pattern formed by the sensors 21 and suspension lead wires 42 can be set by a user according to reality rather than limited by the disclosure.

Furthermore, the array substrate further includes a touch control driver and a peripheral lead wire, each of the sensors is connected to the touch control driver by the peripheral lead wire. The touch control lead wire corresponding to each of the sensors and the peripheral lead wire are connected electrically.

In a specific embodiment of the disclosure, the array substrate 100 further includes a touch control driver 50 and peripheral lead wires 60, the peripheral lead wires 60 and the sensors 21 are corresponding respectively. Each of the sensors 21 is electrically connected to the touch control driver 50 by the peripheral lead wires 60. Moreover, in the plurality of touch control lead wires 41 corresponding to each of the sensors 21, at least two of the touch control lead wires 41 are connected parallel and subsequently connected to the peripheral lead wires 60, and connected to the touch control driver 50 by the peripheral lead wires 60. The connection of the plurality of the touch control lead wires 41 and the peripheral lead wires 60 can improve stability of the connection and reduce malfunctions caused by disconnection of one of the touch control lead wires 41.

Furthermore, during a touch control process of the touch control driver 50, a pulse signal can be loaded on the sensors 21 to detect a contact position of a finger by the sensors 21. During display, the sensors 21 can be utilized as the common electrode as well, which is the touch control driver 50 can apply a signal with a constant voltage on the touch control lead wires 41 and the suspension lead wires 42, thereby liquid crystal molecules can rotate under combined influence of the common electrode and the pixel electrode to display.

In an optional implementation manner of the embodiment, the touch control lead wires 41 and the suspension lead wires 42 adopt the same material. In the embodiment of the disclosure, the material of the touch control lead wires 41 is transparent conductive material or metallic material. The material of the touch control lead wires 41 is preferably the transparent conductive material, such as indium tin oxide (ITO), indium zinc oxide (IZO) or a combination of the two.

Preferably, the material of the sensors 21 can be transparent conductive material, such as indium tin oxide (ITO), indium zinc oxide (IZO) or a combination of the two. During producing the sensors 21, the transparent conductive material above can be firstly formed to be a conductive layer, then an electrode pattern is formed on the conductive layer by a process such as etching. The sensors 21 can be obtained by the electrode pattern.

Based on the array substrate 100 provided above, referring to FIG. 3, the disclosure further provides a touch display 200. In the embodiment, the touch display includes the array substrate 100 described in any of the embodiments above and a color film substrate 101 disposed opposite to the array substrate 100, a liquid crystal layer 102 is disposed between the array substrate 100 and the color film substrate 101. A color film layer not shown in the figure is disposed on the color film substrate 101, and the color film layer is disposed on a side of the color film substrate 101 towards the liquid crystal layer 102.

Based on the touch display 200 provided above, the disclosure further provides an electric device, the electric device can include any device or component with a display function such as electric paper, a liquid crystal television, a mobile phone, a digital photo frame, a tablet, etc.

The embodiments described above do not limit the protection scope of the disclosure. Any modification, equivalent replacement or improvement within the spirit and principles of the embodiments described above should be covered by the protected scope of the disclosure.

What is claimed is:

1. An array substrate, at least comprising a substrate; a common electrode layer, an insulating layer and a sensing layer disposed on the substrate overlapped in sequence, the common electrode layer comprising a plurality of sensors, the plurality of sensors being disposed separately, a touch control lead wire and a suspension lead wire being disposed on the sensing layer corresponding to each of the sensors, the touch control lead wires being connected to the sensors electrically through a first via hole, the suspension lead wire and the touch control lead wire being separated and disposed parallel, and the suspension lead wires being connected to the sensors electrically through a second via hole.

2. The array substrate according to claim 1, wherein the plurality of sensors are arrayed as an array, each of the sensors is corresponding to two or more touch control lead wires and one suspension lead wire respectively.

3. The array substrate according to claim 2, wherein the plurality of touch control lead wires corresponding to the identical sensor are arranged parallel, each of the touch control lead wires and the sensors are connected electrically through the plurality of first via holes.

4. The array substrate according to claim 2, wherein the plurality of touch control lead wires corresponding to the identical sensor and the suspension lead wires are arranged parallel with an identical extension direction.

5. The array substrate according to claim 1, wherein the suspension lead wires of the plurality of sensors are insulated respectively, and each of the suspension lead wires and the corresponding sensor are connected electrically through the second via hole.

6. The array substrate according to claim 1, wherein the array substrate further comprises a touch control driver and a peripheral lead wire, each of the sensors is connected to the touch control driver by the peripheral lead wire.

7. The array substrate according to claim 6, wherein the touch control lead wire corresponding to each of the sensors and the peripheral lead wire are connected electrically.

8. The array substrate according to claim 1, wherein the touch control lead wires and the suspension lead wires are metallic wires disposed on the insulating layer.

9. The array substrate according to claim 1, wherein the array substrate further comprises a gate line and a data line crosswise arranged on the substrate, the touch control lead wires are above the gate line, the touch control lead wires and the gate line are insulated.

10. A touch display, comprising an array substrate, the array substrate at least comprising a substrate; a common electrode layer, an insulating layer and a sensing layer disposed on the substrate overlapped in sequence, the common electrode layer comprising a plurality of sensors, the plurality of sensors being disposed separately, a touch control lead wire and a suspension lead wire being disposed on the sensing layer corresponding to each of the sensors, the touch control lead wires being connected to the sensors electrically through a first via hole, the suspension lead wire and the touch control lead wire being separated and disposed parallel, and the suspension lead wires being connected to the sensors electrically through a second via hole.

11. The touch display according to claim 10, wherein the plurality of sensors are arrayed as an array, each of the sensors is corresponding to two or more touch control lead wires and one suspension lead wire respectively.

12. The touch display according to claim 11, wherein the plurality of touch control lead wires corresponding to the identical sensor are arranged parallel, each of the touch control lead wires and the sensors are connected electrically through the plurality of first via holes.

13. The touch display according to claim 11, wherein the plurality of touch control lead wires corresponding to the identical sensor and the suspension lead wires are arranged parallel with an identical extension direction.

14. The touch display according to claim 10, wherein the suspension lead wires of the plurality of sensors are insulated respectively, and each of the suspension lead wires and the corresponding sensor are connected electrically through the second via hole.

15. The touch display according to claim 10, wherein the array substrate further comprises a touch control driver and a peripheral lead wire, each of the sensors is connected to the touch control driver by the peripheral lead wire.

16. The touch display according to claim 15, wherein the touch control lead wire corresponding to each of the sensors and the peripheral lead wire are connected electrically.

17. The touch display according to claim 10, wherein the touch control lead wires and the suspension lead wires are metallic wires disposed on the insulating layer.

18. The touch display according to claim 10, wherein the array substrate further comprises a gate line and a data line crosswise arranged on the substrate, the touch control lead wires are above the gate line, the touch control lead wires and the gate line are insulated.
